(19) United States
(12) Patent Application Publication
(10) Pub. No.: US 2026/0140723 A1
(43) Pub. Date: May 21, 2026

(54) AUTOMATICALLY OPTIMIZING COMPUTER CODE AT SCALE USING GENERATIVE NEURAL NETWORKS

(71) Applicant: Google LLC, Mountain View, CA (US)

(72) Inventors: Milad Olia Hashemi, San Francisco, CA (US); Christopher Thomas Kennelly, Croton-on-Hudson, NY (US); Margaret Nolan Edmonds, Kirkland, WA (US); Yusuf Ali Simonson, Raleigh, NC (US); Martin Christoph Maas, Mountain View, CA (US); Satish Chandra, Palo Alto, CA (US); Florin Papa, Brentwood, CA (US); Aditya Patil, Apex, NC (US); Deniz Altinbuken, Mountain View, CA (US); Donald Herbert Schwarz, Chicago, IL (US); Parthasarathy Ranganathan, San Jose, CA (US); Hannah Lin, San Jose, CA (US); Eric Maximilian Roquemore, Austin, TX (US); Tzu Wei Yang, Menlo Park, CA (US); Frederick Willard Lewis, III, Bellevue, WA (US); Amir Yazdanbakhsh, San Jose, CA (US); Arman HasanzadehMoghimi, Santa Clara, CA (US)

(21) Appl. No.: 19/295,457

(22) Filed: Aug. 8, 2025

Related U.S. Application Data
(60) Provisional application No. 63/681,748, filed on Aug. 9, 2024.

(51) Int. Cl. G06F 8/41; G06F 8/35; G06F 8/36

(52) U.S. Cl. CPC G06F 8/443; G06F 8/35; G06F 8/36

(57) ABSTRACT

Methods, systems, and apparatuses, including computer programs encoded on computer storage media, for identifying a plurality of candidate code segments that are candidates for optimization and, for each of the plurality of candidate code segments, generating a respective optimized computer code segment using a generative neural network, where the generative neural network processes an input that includes candidate computer code segment to generate the optimized computer code segment. Because the described techniques selectively identify the candidate code segment and use the generative neural network to generate the respective optimized computer code, the described techniques scale the optimization of computer code belonging repositories that include billions or more lines of code.

### CROSS-REFERENCE TO RELATED APPLICATIONS

This application claims priority of U.S. Provisional Application No. 63/681,748, filed Aug. 9, 2024. The contents of the prior application is incorporated herein by reference in its entirety.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that optimizes computer code from a repository of computer code, e.g., a repository that stores computer code for execution on a set of computing resources, e.g., on a cluster of devices, in a data center, or on a fleet of devices distributed across multiple data centers.

“Optimizing” computer code generally refers to generating a version of the computer code (i.e., optimized computer code) that carries out the same function as the original code (i.e., unoptimized computer code) but through a different set of high-level operations that cause the optimized computer code to execute more efficiently on the set of computing resources than the original code, e.g., with reduced latency, with reduced processor usage, and so on.

Particular embodiments of the subject matter described in this specification can be implemented so as to realize one or more of the following advantages.

Computer code is often unoptimized during initial development because programmers prioritize readability of the computer code over maximum efficiency (i.e., over minimized latency and minimized compute resource requirements during execution of the computer code). But as computer code grows larger and more complex and is executed using large amounts of compute resources (e.g., multiple data centers) even a minor amount of inefficiency due to unoptimized code results in enormous waste of computing resources. Thus, unoptimized code needs to be optimized to avoid unacceptable increased inefficiencies, e.g., execution latency and compute resource requirements.

Some techniques to execute unoptimized computer code more efficiently on a set of computer resources rely on compilers, optimized library linking, and hardware acceleration. While these techniques do improve computational performance and cost associated with the execution of the unoptimized computer code by optimizing the low-level operations of individual high-level operations in unoptimized computer code, the improvements they provide are limited by the collective high-level operations in the unoptimized computer code. That is, these techniques can optimize how a high-level operation is performed but cannot optimize algorithmic inefficiencies of a collection of high-level operations that make up the unoptimized computer code; and because the algorithmic inefficiencies are responsible for the majority of the inefficient execution of unoptimized computer code, these techniques are limited in how much they can improve the efficiency of unoptimized computer code execution.

For example, for unoptimized computer code that repeatedly looks up the same key in a map data structure within a loop, techniques that rely on a compiler, optimized library linking, and hardware acceleration to execute computer code more efficiently will fail to significantly improve computational performance associated with the computer code. That is, the compiler, and optimized library linking utilize rules-based optimization to improve performance of individual high-level operations of the unoptimized computer code, and the hardware acceleration executes specific, low-level operations more quickly, but none of these techniques prevent the redundant map look ups. That is, significantly improving the performance associated with this unoptimized computer code would require avoiding the repeated look ups and to, e.g., instead store the output of a single look up for reuse, which none of these techniques can accomplish and can only be accomplished through optimizing the computer code.

Furthermore, even though optimizing computer code improves the efficiency of computer code execution, identifying candidate code segments to be optimized and optimizing the candidate code segments is challenging.

For example, some techniques optimize code through rules based custom transformations applied indiscriminately to computer code segments, but these techniques fall short of robustly identifying and optimizing computer code at scale. That is, these techniques only optimize code using a limited custom transformation and do not selectively identify code segments for code optimization. Therefore, these techniques are computationally costly to apply to large code repositories (e.g., a repository of computer code containing billions of lines of computer code) and are limited in the code optimization types and transformations they can apply to code segments.

As a particular example, a static code line analysis tool may use a pre-defined rule to detect and then replace inefficient performing codes lines of a code segment. However, this approach is limited, as the detection and replacement only work for straightforward matching of code lines and fails to identify the same optimization opportunity in more complex computer code segments. Additionally, the tool must still process all code segments of the repository of computer code, making it a computationally costly method for finding a narrow set of optimizations.

As another example, some techniques optimize code through the use of a generative neural network to suggest or apply code transformations for a code segment. However, just using a generative neural network to process all code segments of a repository of computer code to generate corresponding optimized code segments is prohibitively computationally expensive. Additionally, while the generative neural network can produce optimized code segments that are syntactically valid, often the generated code segments are functionally incorrect, contain logical flaws, or do not optimize the code appropriately. This unreliability arises because the generative neural network lacks a way to guide the generation of output that represents the optimized computer code segment, leading to unpredictable results, making the resulting optimized code unreliable for use in a production environment that requires a high standard of quality.

This specification describes techniques that can address the aforementioned challenges. That is, this specification describes techniques for identifying a plurality of candidate code segments for optimization in a repository of computer code and, for each identified candidate code segment, using a generative neural network to process an input that includes the identified candidate code segment to generate an optimized computer code segment that represents an optimized version of the identified candidate code segment.

Because identifying the plurality of candidate code segments for optimization includes identifying one or more respective segment embeddings of candidate code segments that are similar to the respective archetype embedding for a performance optimization archetype, the described techniques can efficiently identify candidate code segments for optimization. For example, by using embedding representations of each performance optimization archetype in a set of one or more performance optimization archetypes and candidate code segments, the described techniques can efficiently identify candidate code segments for optimization using highly optimized vector similarity search (e.g., approximate nearest neighbor search) instead of using inefficient methods such as exact code matching. Then, because only appropriate candidate code segments for optimization are identified, the described techniques can use the generative neural network to generate optimized code segments for an entire repository of computer code. Thus, the described techniques are designed to work at the scale of billions of lines of code, making it feasible to locate nuanced optimization opportunities in massive code repositories.

For example, the described techniques work for a repository of computer code that contains all projects of an organization (e.g., projects for web-services, database systems, etc.) that cumulatively includes billions of lines of code and is executed on thousands to millions of servers, storage devices and networking equipment, often spread across numerous data centers worldwide. Without the selective identification of candidate code segments, the generative neural network would need to process an unwieldy number of inputs to generate optimized code segments.

Additionally, when the describe techniques identify the plurality of candidate code segments for optimization for a set of one or more performance optimization archetypes, the describe techniques can identify candidate code segments for one or more optimization types (represented through the set of one or more performance optimization archetypes). That is, the described techniques identify a plurality of candidate code segments for optimization for a plurality of optimization types. By identifying candidate code segments for multiple optimization types, e.g., reducing unnecessary allocations, eliminating redundant map operations, or adding missing vector reserves, the described techniques can address a much broader spectrum of performance optimization opportunities. Thus, the described techniques can generate optimized code segments that represent more than just minor improvements from targeting just one type of performance optimization opportunity.

Also, the described techniques can optimize computer code for execution on a specific, defined set of computational resources. That is, the described techniques include maintaining respective performance metrics for each of a plurality of code segments in a repository of computer code that measure a performance of the code segment when the code segment has been executed on a set of computing resources; and determining not to maintain respective segment embeddings of some of the plurality of code segments based on the respective performance metrics for the plurality of code segments. Therefore, a candidate code segment for optimization can be identified based on data of performance metrics from the set of computational resources, ensuring the identified candidate code segment for optimization is specifically relevant to the operational characteristics of the particular hardware and its workloads present in the set of computational resources.

As an example of how the described techniques uses performance data from a specific environment to identify and tailor optimizations to its unique operational characteristics, consider two different fleets of devices with different sets of hardware (e.g., different set of hardware accelerators and specific hardware configurations) and receiving different inputs but executing the same computer code from copies of the same repository of computer codes. The differences in hardware and received inputs for the two environments cause the respective performance metrics for each of the plurality of code segments that each fleet executes to be different from each other. Thus, different segment embeddings of the code segments will be maintained for each fleet that reflects the differences of the environments of the fleets, causing different code segments to be optimized according to the specific environment the code segments are executed on.

Also, using a generative neural network to process an input that includes the identified candidate code segment to generate an optimized computer code segment allows for complex and sophisticated code optimization out of reach for other techniques. That is, the described techniques' fine-tuning the generative neural network on training data derived from optimization archetypes, including a prompt in the input (e.g., a zero-shot prompt, chain-of-thought prompt, a ReAct prompt, and so on), or both enable the generative neural network to generate correct and complex optimized code segments that represent the application of code transformations to candidate code segments. Without the use of this generative neural network to process an input that includes the candidate computer segment, the possible code transformations applied to candidate code segments are limited and not reliable.

As an example of the performance of the described techniques, when the described techniques are applied to a large production repository of computer code that includes billions of lines of code executed on a hyperscale production fleet, more than 25 k code lines of computer code are changed across over 6.4 k submitted commits with a >99.5% production success rate (i.e., 99.5% of changed computer code lines successfully optimized the original code lines and were added to the production repository). Over a year's time, the resulting improved computational efficiency of the optimized code determined by the described techniques saves the equivalent to over 2 million normalized CPU cores.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an efficient code optimization system.

FIG. 2 is a flow diagram of an example process for generating optimized computer code segments by using a generative neural network to process respective inputs that include identified candidate code segments.

FIG. 3 is a flow diagram of an example process for performing a search through a repository of computer code to identify a plurality of candidate code segments that are candidates for optimization.

FIG. 4 is a flow diagram of an example process for fine-tuning a deep embedding model.

FIG. 5 is a flow diagram of an example process for fine-tuning a generative neural network.

FIG. 6 is an example of the performance of the described techniques.

FIG. 7 is an example of the performance of the described techniques.

FIG. 8A is an example of the performance of the described techniques.

FIG. 8B is an example of the performance of the described techniques.

Like reference numbers and designations in the various drawings indicate like elements.

### DETAILED DESCRIPTION

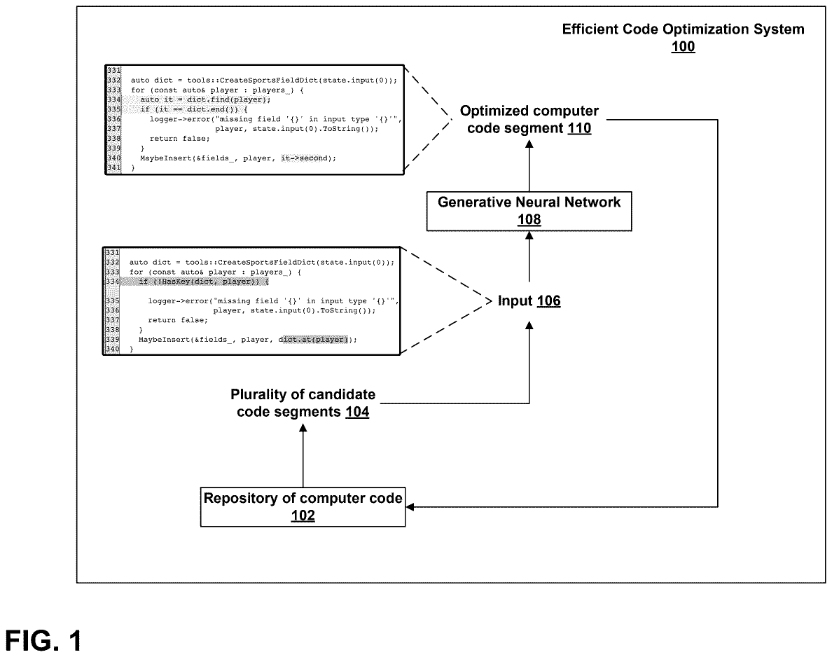

FIG. 1 shows an efficient code optimization system 100. The system 100 is an example of a system implemented as computer programs on one or more computers in one or more locations, in which the systems, components, and techniques described below can be implemented.

The efficient code optimization system 100 optimizes computer code within a repository of computer code 102 by identifying a plurality of candidate code segments 104 for optimization and generating optimized computer code segments 110 for the plurality of candidate code segments 104. The system 100 then adds the optimized computer code segments 110 to the repository 102 for execution on a set of computing resources.

The set of computing resources can be any set of hardware belonging to one or more computers, including their processors and memory. The resources can be organized in various ways, such as a cluster of devices, a centralized data center, or a vast fleet of devices distributed geographically across multiple data centers.

The optimized computer code segment 110 of a corresponding computer code segment 104 is optimized in that the optimized computer code segment 110 carries out the same function as the original code segment 104 but is more efficient to execute on the set of computing resources than the original computer code is on the same set of computing resources. This improved efficiency is specifically tailored to the hardware of the set of computing resources because the system identifies the corresponding computer code segment 104 according to specific inefficiencies of the computing resources executing the computer code.

Improved efficiency can refer to how well compute resources are utilized. For example, improved efficiency can refer to reduced latency (i.e., execution time for the code) or reduced compute resource requirement (e.g., fewer CPU cores, less RAM, and so on).

The repository of computer code 102 can be any of a variety of types of repositories. For example, the repository of computer code 102 can be a version-controlled repository (with searchable code commits). As another example, the repository of computer code 102 can include a single repository with any number of lines of code (e.g., billions of lines of code). The repository can also include multiple smaller repositories, each with any number of lines of code.

The computer code included in the repository of computer code 102 can be any of a variety of types of computer code. For example, the computer code can be code in a programming language, e.g., Python or C++, code in a markup language, e.g., HTML or XML, code in a scripting language, e.g., JavaScript, and so on.

More specifically, the system 100 repeatedly searches through the repository of computer code 102 to identify candidate code segments 104.

For each identified candidate code segment 104, the system 100 processes an input 106 that includes the candidate code segment 104 using a generative neural network 108 to generate an optimized version of the candidate code segment 110.

The system 100 can then add the optimized version of the candidate code segment 110 to the repository 102, e.g., as a modification to the candidate code segment 104, in place of the candidate code segment 104, or as a new candidate code segment.

A computer code segment can be any appropriate portion of computer code that includes multiple lines of computer code. For example, the computer code segment can be a source code file or a portion of a source code file, e.g., the portion of a source code file corresponding to a single function. As another example, the computer code segment can be a code diff between a before code segment and an after code segment (i.e., lines of computer code that are added, removed, or modified to transform the before code segment to the after code segment).

As described above, the computer code can be any appropriate type of computer code in any appropriate language. For example, the computer code can be code in a programming language, e.g., Python or C++, code in a markup language, e.g., HTML or XML, code in a scripting language, e.g., JavaScript, and so on.

The generative neural network 108 can be any appropriate neural network that receives as input a sequence of tokens and processes the sequence of tokens to generate an output sequence of tokens. A ‘token’ is data that represents a unit of data, e.g., a text symbol or data of another modality, e.g., a portion of an image, audio signal, or video signal. For example, a ‘token’ can be a one-hot vector or a dense embedding.

In some cases, the generative neural network 108 is a pre-trained neural network (i.e., the system or another system has previously determined the values of the trainable parameters of the generative neural network 108 through training on large data sets for one or more general tasks, e.g., next token prediction, image captioning, text-image alignment, and so on).

In some cases, the generative neural network 108 is a language model neural network that processes tokens representing text symbols or a multi-modal language model neural network that can process tokens representing text symbols and tokens representing data of one or more other modalities, e.g., image, video, audio, and so on. As a particular example, the generative neural network 108 can be an auto-regressive neural network that generates the tokens in the output sequence auto-regressively, i.e., one after another. One example of such a generative neural network is a decoder-only Transformer neural network. Examples of such neural networks include neural networks that belong to the Gemini family of neural networks or Gemma family of neural networks.

Optionally, the system 100 can also include, in the input sequence to the generative neural network 108, a prompt, and the prompt can include instructions that cause the generative neural network 108 to optimize the input code segment, e.g., a zero-shot prompt, a few-shot prompt, a natural language instruction, a chain of thought prompt, a ReAct prompt, or any combination of these.

Further optionally, prior to using the generative neural network 108, the system 100 can “fine-tune,” i.e., further train, the generative neural network on training data that is specific to the code optimization task.

In some implementations, to perform the search through the repository of computer code 102 to identify candidate code segments 104, the system 100 maintains a respective archetype embedding of each performance optimization archetype in a set of one or more performance optimization archetypes. In some cases, the system also maintains a respective segment embedding of each of a plurality of code segments in the repository 102.

A performance optimization archetype is a canonical example of a category of performance-improving code transformations. For example, a performance optimization archetype can be a representative code segment representing code lines that can be optimized to remove unnecessary memory allocations, where removing unnecessary memory allocations is the category of performance-improving code transformations. So, an archetype embedding is an embedding representation (i.e., a numeric vector representation) of a performance optimization archetype. When there are multiple performance optimization archetypes in the set of one or more performance optimization archetypes, each can be a canonical example of a respective different category of performance-improving code transformations. So, each archetype embedding will be different from each other and represent a different category of performance-improving code transformations. Additionally, a segment embedding is an embedding representation of a code segment.

Then, for one or more of the performance optimization archetypes in the set, the system 100 performs a search of the respective segment embeddings to identify one or more respective segment embeddings that are similar to the respective archetype embedding for the performance optimization archetype. Afterwards, the system 100 identifies, as candidate code segments 104, the code segments that are represented by the respective segment embeddings that are similar to the respective archetype embedding.

In some implementations, to search for and identify one or more respective segment embeddings that are similar to the respective archetype embedding for the performance optimization archetype, the system 100 outputs an initial set of segment embeddings (e.g., using a nearest neighbor algorithm to determine one or more respective segment embeddings that are most similar to the respective archetype embedding) and then filters the initial set of segment embeddings based on respective similarities (e.g., syntactic similarities) of the code segments represented by the initial set of segment embeddings to the representative code segment for the optimization archetype.

In some cases, the system 100 also maintains respective performance metrics for each of the plurality of code segments in the repository 102 that measure a performance of the code segment when the code segment has been executed on the set of computing resources (e.g., compute usage, e.g., number of low-level instructions or processor cycles required to execute the computer code segment).

In some cases, the system 100 uses the respective performance metrics for each of the plurality of code segments in the repository 102 to determine which code segments the system 100 maintains the segment embedding of. For example, the system 100 can determine not to maintain the respective segment embedding for those code segments with corresponding performance metrics that have less than a threshold level of compute usage (e.g., the compute usage defined here as number of processor cycles being less than a pre-determined number). By not maintaining these respective segment embedding, the system 100 ensures that only code segments associated with significant compute usage will be identified for optimization, which will prioritizes the identification of code segments with the potential for the most substantial improvements in efficiency and will avoid wasteful processing of code segments using the generative neural network 108 that even if optimized will not significantly improve the overall efficiency of the set of computer resources.

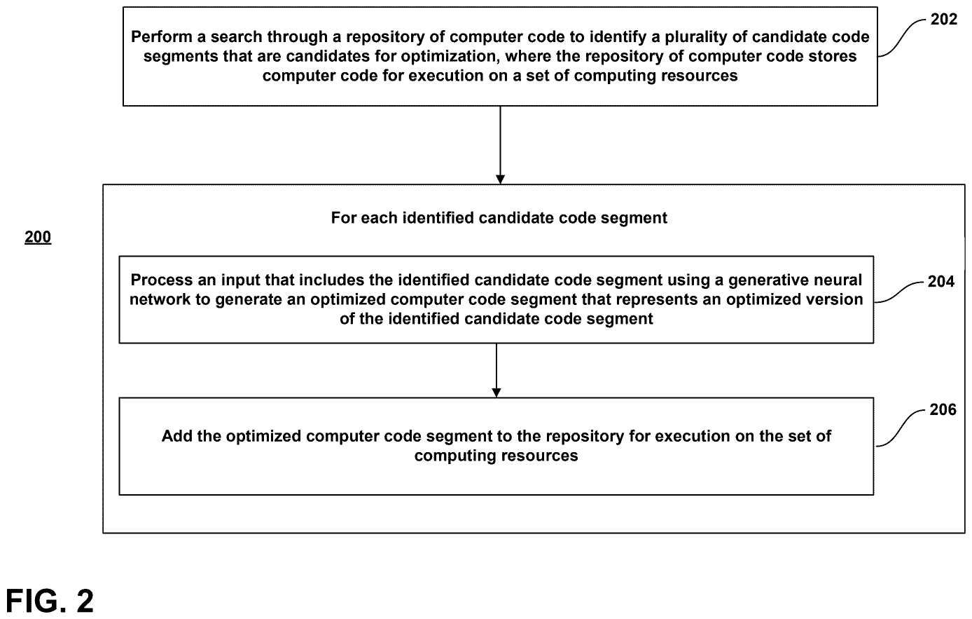

FIG. 2 is a flow diagram of an example process 200 for generating optimized computer code segments by using a generative neural network to process respective inputs that include identified candidate code segments. For convenience, the process 200 will be described as being performed by a system of one or more computers located in one or more locations. For example, an efficient code optimization system, e.g., the efficient code optimization system 100 of FIG. 1, appropriately programmed in accordance with this specification, can perform the process 200.

The system performs a search through a repository of computer code to identify a plurality of candidate code segments that are candidates for optimization (step 202). Generally, the repository of computer code stores computer code for execution on a set of computing resources.

For example, the repository of computer code can be an organized storage system for computer code and related files, designed to manage, track changes, and facilitate the execution of that code on a range of computing resources.

Generally, the range of computing resources encompasses any of a variety of diverse hardware, software, and network components available to perform computational tasks, from individual devices to large-scale cloud infrastructure.

For example, the range of computing resources can encompass a hyperscale production fleet, i.e., thousands to millions of servers, storage devices and networking equipment, often spread across numerous data centers worldwide.

As described above, a computer code segment can be any appropriate portion of computer code that includes multiple lines of computer code. So, a candidate computer code segment for optimization can be any appropriate portion of computer code that includes multiple lines of computer code that can be optimized.

For example, the plurality of code segments can be disjoint code segments that constitute the computer code of the repository of computer code. For example, the system can use a data processing framework, e.g., Apache Beam, to crawl a repository of computer code, e.g., repository of C++ computer code, to parse each source code file with a compiler frontend, e.g., Clang, and divide it into functions, where each function corresponds to lines of code that constitute a code segment.

As an example of step 202, the system can use regular expressions (i.e., sequences of characters that specifies match patterns in text) to search for code segments that follow a particular pattern of computer code symbols and the pattern can be associated with code that can be optimized. So, code segments that the system finds that match the regular expression can be the identified plurality of code segments for optimization. For example, a regular expression can be used to identify code segments that include a string find function call with a string literal of a single character, e.g., str.find(“A”), which could be optimized by replacing it with a more efficient call to an overload of the ‘find’ function designed for single character, e.g., str.find(‘A’).

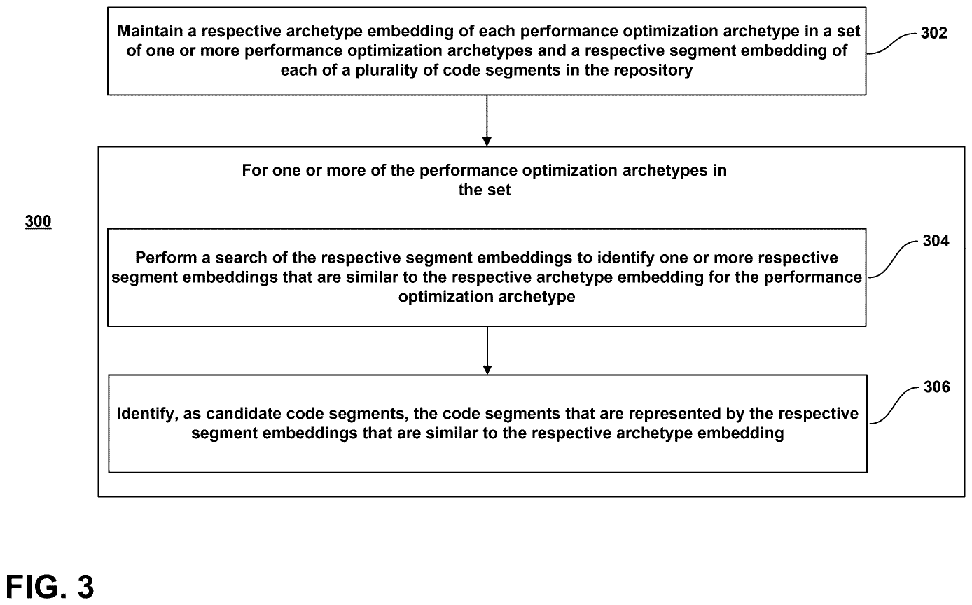

Another example of performing a search through a repository of computer code to identify a plurality of candidate code segments that are candidates for optimization are described below with reference to FIG. 3 below.

FIG. 3 is a flow diagram of an example process 300 for performing a search through a repository of computer code to identify a plurality of candidate code segments that are candidates for optimization. For convenience, the process 300 will be described as being performed by a system of one or more computers located in one or more locations. For example, an efficient code optimization system, e.g., the efficient code optimization system 100 of FIG. 1, appropriately programmed in accordance with this specification, can perform the process 300.

The system maintains a respective archetype embedding of each performance optimization archetype in a set of one or more performance optimization archetypes and a respective segment embedding of each of a plurality of code segments in the repository (step 302).

In some implementations, the system also maintains respective performance metrics for each of a plurality of code segments in the repository that measure a performance of the code segment when the code segment has been executed on the set of computing resources.

The performance metrics can include any measure of a code segment's execution efficiency on the set of computing resources. For example, a performance metric can be a measure of execution time (i.e., how long the code segment takes to execute), compute usage (e.g., percentage of the total available CPU(s) the computer code segment is utilizing during execution, number of CPU cycles the code segment requires to execute, or number of CPU level instructions the code segment requires to execute), memory usage (e.g., how much computer memory the code segment is utilizing during execution, the number lower level cache (LLC) misses during the code segment's execution), and so on.

The system can obtain the respective performance metrics for each of a plurality of code segments in the repository to maintain from a user or another system. The system can also determine the respective performance metrics. For example, the system can use a continuous profiling framework to collect the performance metrics of code segments (e.g., performance metrics of codes segments that represent computer program functions) while executing the code segments on the set of computing resources. As a particular example, for a set of computing resources that is a fleet of devices, the system can use a fleet-wide continuous profiling framework that periodically samples performance metrics from running applications. For each sample, this framework can collect detailed information that links performance metrics to specific executed code segments. The system can then aggregate and store in a global database this collected profile data of performance metrics to maintain a record of the performance metrics for the executed code segments.

In some cases, the plurality of code segments that the system maintains segment embeddings for are a proper subset of the code segments for which the system maintains performance metrics. In these cases, the system determines not to maintain respective segment embeddings for certain ones of the code segments based on their respective performance metrics.

In some cases, the determination not to maintain respective segment embeddings for certain ones of the code segments can be based on the respective performance metrics for those code segments indicating less than a threshold level of compute usage.

The compute usage of a code segment refers to any measure of consumption of processing power or resources of the set of computing resources. For example, compute usage can be the percentage of the total available CPU(s) the computer code segment is utilizing during execution, the number of CPU cycles the code segment requires to execute, or number of CPU level instructions the code segment requires to execute.

A code segment having less than a threshold level of compute usage refers to the code segment consumption of resources during execution of the code segment on the set of computing resources being below a threshold level. So, for example, if compute usage is defined as percent of total CPU cycles the set of computing resource spends executing the code segment (i.e., Cₘᵢₙ) and the system determines a threshold level of Cₘᵢₙ=0.1%, the system can determine to not maintain the respective segment embeddings of code segments with associated performance metrics of Cₘᵢₙ<0.1%.

Because not every code segment has the same potential for optimization improvement, maintaining the segment embeddings for only a subset of the plurality of code segments based on their respective performance metrics makes the system more computationally efficient while maintaining its performance. The system is more computationally efficient because, e.g., it can save computational memory and processing power by not maintaining as many segment embeddings, not generating as many embeddings, and having a smaller search space (due to maintaining fewer segment embeddings) when it performs a search through the repository of computer code to identify the plurality of candidate code segments that are candidates for optimization.

The system maintains its performance because, e.g., code segments associated with less than a threshold level of compute usage do not contribute substantially to the computational cost of the overall execution of the computer code of the repository on the set of computing resources. Therefore, not identifying optimization opportunities among these code segments does not meaningfully affect the efficiency of execution of the computer code of the repository on the set of computing resources. For the previous example, code segments associated with Cₘᵢₙ<0.1% are not worth maintaining the respective segment embeddings of because even if the code segments were optimized they are such a small portion of the total execution cost that it would contribute negligibly to the improved efficient execution of the computer code of the repository on the set of computing resources.

The respective performance optimization type corresponding to each performance optimization archetype, can correspond to any of a variety of types of performance optimizations that improve computational efficiency associated with computer code. For example, for code written in the C++ computer programming language, computational efficiency can correspond to addressing unnecessary memory allocations, unnecessary copying of objects, redundant operations, unnecessary sorting, inefficient memory allocation, and so on.

In some cases, each performance optimization archetype corresponds to a respective set of one or more anti-pattern fixing commits that each fix undesirable code usage of code within the repository.

An anti-pattern refers to a common pattern in computer code that, while appearing to be valid, is known to be inefficient or suboptimal (i.e., unoptimized). The term “anti-pattern” is used because it is the conceptual opposite of a “design pattern,” which represents a best practice. An anti-pattern, therefore, represents a common but undesirable practice in computer code that should be refactored (i.e., optimized). Examples of anti-patterns include performing redundant map operations, creating unnecessary copies of data objects, or failing to pre-allocate memory for a vector.

A commit is a snapshot of a repository of computer code that includes a commit message, code review comments, before/after snapshots of changes to code line (i.e., lines of computer code that are added, removed, or modified), and so on.

The system can determine each set of one or more anti-pattern fixing commits using the information included in the commits of the repository of computer code. For example, the system can use textual search techniques to find historical commits that have previously improved performance. For example, the system can search through the full set of commits of the repository of computer code and filter for certain keywords in the commit messages. This includes benchmark results, keywords that indicate reduced compute or memory cost, hashtags from software engineers that indicate performance improvements, and references to optimization tutorials and other performance-related documentation.

In some cases, each set of one or more anti-pattern fixing commits can include anti-pattern fixing commits from other repositories. For example, the system can search through a set of curated data sources to find anti-pattern fixing commits and include these in a set of one or more anti-pattern fixing commits.

In some implementations, each performance optimization archetype is associated with a representative code segment that serves as a concrete, canonical example of the performance optimization type. For example, the representative code segment can be a function from a source code file that contains “unnecessary copying of objects”, which is useful for finding other functions with similar overall structure. Alternatively, the representative code segment can be a code diff of the function from the source code file that contains “unnecessary copying of objects” from a historical commit that address the “unnecessary copying”.

In some cases, for one or more of the optimization archetypes, the representative code segment represents one or more code segments that have been fixed by the respective set of one or more anti-pattern fixing commits. For example, the representative code segment can be for a function from a source code file that contains the anti-pattern and is present in the set of anti-pattern fixing commits.

Further in some cases, for one or more of the optimization archetypes, the representative code segment represents a code diff corresponding to the respective set of one or more anti-pattern fixing commits. For example, the representative code segment can be a code diff of a function from a source code file that contains the anti-pattern and is present in the set of anti-pattern fixing commits.

An embedding refers to a numeric vector representation of a point in n-dimensional embedding space, where n can be any positive integer. The embedding design for archetype embeddings and segment embeddings can be any of a variety of types of designs.

For example, the embedding design can be based on frequency counts of text tokens belonging to a vocabulary for a text token representation of a code segment (i.e., “Bag of Words”). That is, the system can map each character, word, or sub-word of the natural language text representation of a code segment to a corresponding token by applying a text tokenizer to the code segment. For example, the system can apply the Byte-Pair Encoding (BPE), WordPiece, or SentencePiece tokenizers to divide the natural language text data into tokens from a vocabulary. Then, the system can count the occurrence frequency of words in the code segment and represent the frequencies as an n-dimensional vector, where n is number of tokens in the vocabulary.

In some implementations, the system generates the respective archetype embedding for the optimization archetype by processing the representative code segment associated with the optimization archetype using a deep embedding model. Additionally in some implementations, the system generates the respective segment embedding of each of the plurality of code segments in the repository by processing the code segment using the deep embedding model.

The deep embedding model can have any of a variety of neural network architectures. That is, the deep embedding model can have any appropriate architecture in any appropriate configuration such that the deep embedding model can process a code segment to generate an embedding representation of the code segment, including fully connected layers, convolutional layers, recurrent layers, attention-based layers, and so on, as is appropriate.

For example, the deep embedding model can be a Transformer-based model. That is, the system processes tokens representing a code segment using a Transformer-based model that uses a self-attention mechanism to produce an embedding from the variable-length code segment. In particular, a special token (e.g., [CLS]) can be added to the start of the token sequence representing the code segment, and the final output vector corresponding to this token generated by the Transformer-based model can be used as the embedding for the code segment. Alternatively, the embedding for the code segment can be determined by applying a pooling operation to the output sequence of vectors to generate a single, fixed-size vector. For example, a mean pooling operation can calculate an element-wise average of all the vectors in the output sequence to produce the embedding. As a particular example, the deep embedding model can be the Gecko model, a 1.2B parameter pre-trained transformer language model that undergoes pre-finetuning and fine-tuning, as described in arXiv: 2403.20327.

In some implementations, the deep embedding model is a dual-embedding model. A dual embedding model has an architecture consisting of two encoders, each of which encodes a respective input into an embedding. For example, the dual embedding model can include two encoders based on a transformer architecture like BERT (Bidirectional Encoder Representations from Transformers), where one encoder is a query encoder that will process a representative code segment associated with an optimization archetype and the other encoder is a candidate encoder that will process candidate code segments.

In some cases, the deep embedding model is a pre-trained model. For example, the deep embedding model can be a dual embedding model that includes a query encoder and a document encoder pre-trained on an English query and document retrieval task. During pre-training of the dual embedding model, the trainable parameters of the encoders can be updated using a contrastive loss function to generate embeddings for pairs of queries and documents that are close together in embedding space when the document is relevant to the query and far away from each other when the documents is not relevant to the query. For this example pre-trained dual-embedding model, the document encoder of the pre-trained model serves as the candidate encoder and the query encoder serves as the query encoder.

In some implementations, the deep embedding model has been fine-tuned on a training data set that includes a plurality of training pairs. Each of the plurality of training pairs includes a code segment for each element of the pair.

For example, when the deep embedding model is a dual-embedding model that includes two encoders, the system processes each training pair by processing one element of the pair using one encoder and the other element of the pair using the other encoder to generate a pair of embeddings, and then the system updates the trainable parameters of the deep embedding model based on an loss function for each pair that includes a similarity metric for the generated pair of embeddings in the embedding space (e.g., a contrastive loss function, e.g., the infoNCE contrastive loss function). For example, the system can optimize the objective using any of a variety of gradient descent techniques (e.g., batch gradient descent, stochastic gradient descent, or mini-batch gradient descent) that include the use of a backpropagation technique to estimate the gradient of the loss with respect to trainable parameters of the deep embedding model and to update the learnable parameters accordingly.

In some cases, for a set of training pairs included in the training data set, each training pair is a semantically similar function pair. That is, both code segments represent computer code lines that produce the same effects or perform the same task but are not the same lines of code.

In some cases, for a set of training pairs included in the training data set, each training pair includes one code segment that is a code diff between a before code segment and an after code segment and another other code segment that is the before code segment. The code diff specifies the set of changes that transform an original before code segment into an optimized after code segment to improve its execution efficiency.

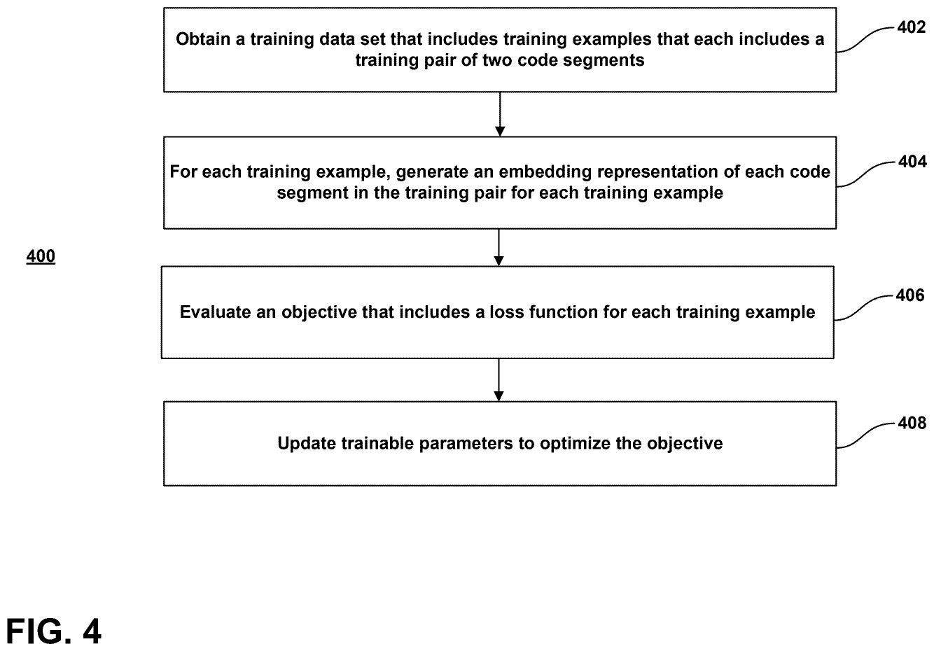

Further details of an example process for fine-tuning the deep embedding model are described below with reference to FIG. 4.

For one or more of the performance optimization archetypes in the set, the system performs steps 304-306.

The system performs a search of the respective segment embeddings to identify one or more respective segment embeddings that are similar to the respective archetype embedding for the performance optimization archetype (step 304).

The system can identify that a pair of embeddings are similar using any of a variety of metrics, e.g., Cosine similarity, Cosine distance, Euclidean distance, Manhattan distance, and so on. For example, the system can determine that a pair of embeddings are similar if the Cosine distance metric of the pair does not exceed a pre-determined threshold.

As an example of the system performing a search, the system can apply an approximate nearest neighbor search algorithm, e.g., the Scalable Nearest Neighbors (ScaNN) method as described in arXiv: 1908.10396, to determine the k embeddings with the lowest Cosine distances as being similar to the respective archetype embedding for the performance optimization archetype, where k is a positive integer, e.g., 100, 300, 500, 800, or 1000 segments.

In some implementations, as part of step 304, the system performs the search of the respective segment embeddings to output an initial set of segment embeddings. The system then filters the initial set of segment embeddings based on respective similarities of the code segments represented by the initial set of segment embeddings to the representative code segment for the optimization archetype. The filtering of the initial set of segment embeddings removes some segment embeddings from the initial set to yield the final set of segment embeddings.

In some cases, the respective similarities of the code segments represented by the initial set of segment embeddings to the representative code segment for the optimization archetype are syntactic similarities. Syntactic similarity between two code segments refers to how alike the lines of code of the code segments are, rather than their functional likeness.

In some cases, the syntactic similarity between two code segments does not consider the non-functional syntax included in the code lines of the code segments, i.e., code lines that are not executed as low-level computational instructions. For example, the system removes custom names, static strings, or comments included in the code lines of the code segments before determining the syntactic similarity between two code segments.

In some cases, the syntactic similarity can be measured using one or more natural language processing performance metrics, e.g., BELU (Bilingual Evaluation Understudy) and ROUGE (Recall-Oriented Understudy for Gisting Evaluation) Scores.

As an example of determining the syntactic similarity, the system can determine the syntactic similarity S between a code segment of an initial segment embedding C and a code segment for an optimization archetype Q as

$$S ( Q , C ) = \frac{1}{4} [ B ( Q , C ) + R ( Q , C ) + T ( Q , C ) + F ( Q , C ) ] ,$$

where B(Q, C), R(Q, C) are BLEU and ROUGE-L text similarity metrics; B and R are calculated after normalizing Q and C to remove custom names, static strings, and comments; T(Q, C)=(|T_{Q}∩Q_{C}|)/(|T_{Q}∪Q_{C}), 1), where T_{Q}, Q_{C} are programming variable types present in Q and C; and F(Q, C) is the Cosine similarity of control flow-related keywords (e.g., for, while) in the code segments' Bag of Words vectors (i.e., Bag of Words vector representation as described above).

The system identifies, as candidate code segments, the code segments that are represented by the respective segment embeddings that are similar to the respective archetype embedding (step 306).

Returning now to the description of FIG. 2, for each identified candidate code segment, the system performs steps 204 and 206.

The system processes an input that includes the identified candidate code segment using a generative neural network to generate an optimized computer code segment that represents an optimized version of the identified candidate code segment (step 204).

In some cases, the optimized code segment is the optimized lines of computer code of the original lines of computer code that the code segment includes. In other cases, optimized computer code segment is a code diff, i.e., lines of computer code that are added, removed, or modified to transform original lines of computer code to the optimized lines of computer code.

The generative neural network can have any of a variety of neural network architectures. That is, the generative neural network can have any appropriate architecture in any appropriate configuration that can process an input that includes the identified candidate code segment to generate an optimized computer code segment that represents an optimized version of the identified candidate code segment, including fully connected layers, convolutional layers, recurrent layers, attention-based layers, and so on, as is appropriate.

In some cases, the generative neural network is a pre-trained neural network (i.e., the system or another system has previously determined the values of the trainable parameters of neural network through training on large data sets for one or more general tasks, e.g., next token prediction, image captioning, text-image alignment, and so on).

In some cases, the generative neural network processes a sequence of tokens to generate, as output, a sequence of tokens from a vocabulary, and the tokens can represent any modality of data such as text, image, audio, video and so on. For example, the generative neural network can be one that belongs to the Gemini family of neural networks, the Gemma family of neural networks, and so on.

In some implementations, the generative neural network is configured to process a sequence of tokens to auto-regressively generate an output sequence of tokens. That is, in some implementations, the generative neural network can be referred to as an auto-regressive neural network when the generative neural network auto-regressively generates an output sequence of tokens. More specifically, the auto-regressively generated output is created by generating each particular token in the output sequence conditioned on a current input sequence that includes any tokens that precede the particular token in the output sequence, e.g., the tokens that have already been generated for any previous positions in the output sequence that precede the particular position of the particular token.

For example, the generative neural network can be an auto-regressive Transformer-based neural network that includes (i) a plurality of attention blocks that each apply a self-attention operation and (ii) an output subnetwork that processes an output of the last attention block to generate the score distribution.

In this example, the generative neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgcaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

In some cases, the generative neural network has been fine-tuned on training data derived from the optimization archetypes.

For example, when each optimization archetype corresponds to a respective set of one or more anti-pattern fixing commits that each fix undesirable code usage of code within the repository, the training dataset can include, for each anti-pattern fixing commit, the before and after code segment according to the commit (i.e., the original code segment and the optimized version of code segment) as a training example. In particular, each training example can include a training input that includes a training code segment that represents the before code segment of the commit and a target output that represents the after code segment of the commit or the code diff of the commit.

As a particular example of a training example, Table 1 illustrates a training example for an anti-pattern fixing commit, where lines 1-14 is the training input and lines 15-17 are the target output. In particular, line 1 simulates a command to display a source file that contains the training code segment; lines 3-5 include the training code segment from the commit (i.e., the before lines of code); and lines 7-12 includes a prompt; and lines 15-17 is the target output that represents a code diff to transform the original code segment to the optimized code segment.

TABLE 1

| | |
|---|---|
| 1: | cat book-logger.cc |
| 2: | ‘‘‘ |
| 3: | #include < string > |
| 4: | #include <vector> |
| 5: | ... |
| 6: | ‘‘‘ |
| 7: | Migrate callers to prefer the Page-returning version |
| 8: | of Read( ) . |
| 9: | We can combine the initialization of the Page object |
| 10: | with the call to Read. |
| 11: | ... |
| 12: | Optimize the code. |
| 13: | patch book-logger.cc |
| 14: | @@ |
| 15: | cursor . Finish ( ) ; |
| | a. Page page; |
| | b. Read(opts, db, user_query, &page); |
| 16: | + Page page = Read(opts, db, user_query) ; |
| 17: | ... |

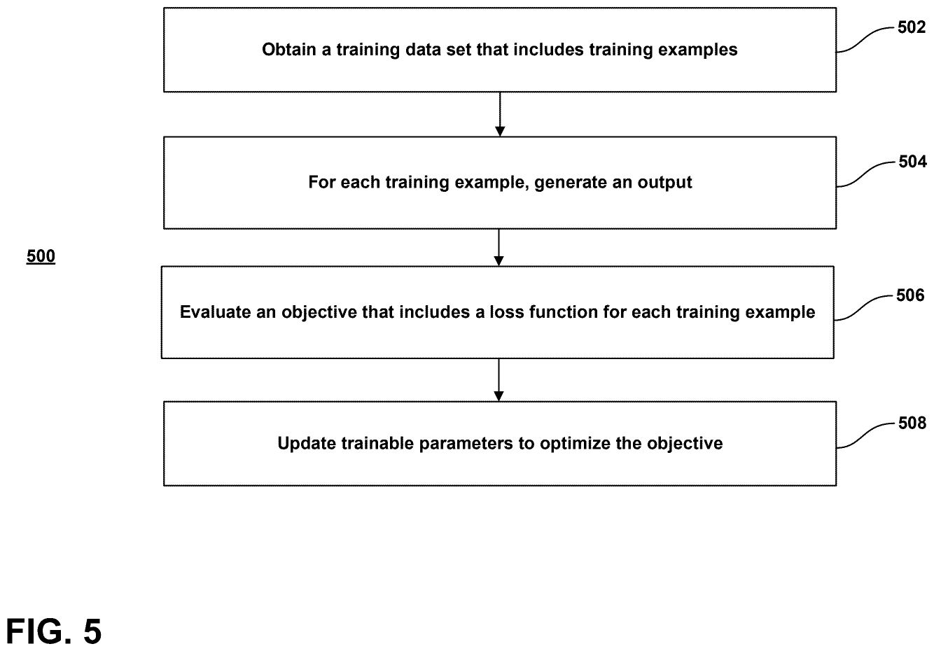

Further details of fine-tuning the generative neural network are described below with reference to FIG. 5.

In some cases, the input for the generative neural network includes the identified candidate code segment and a prompt for the generative neural network. Generally, a prompt includes information that conditions the generative neural network to generate a specific output. For example, the prompt can provide context, instructions, one or more examples, or any combination of these that guides the auto-regressive generation of the sequence of output tokens.

In some cases, the prompt instructs the generative neural network to apply a specific code transformation to the identified candidate code segment. For example, the prompt can include the instructions “Identify and eliminate redundant lookups in map or set operations in C++ to optimize performance.”

In some cases, the prompt instructs the generative neural network to improve a performance of the identified candidate code segment. For example, the prompt can include the instructions of “Optimize the usage of maps.”

As particular example prompt, Table 2 illustrates an example zero-shot prompt with enumerated lines, where line 1 simulates a command to display a source file that includes the code segment using the placeholder {target path} (which is directory path to the source file in the repository of computer code), lines 2-4 include the code segment using the placeholder {target snippet} for the code segment, lines 5-9 include the instruction to improve a performance of the identified candidate code segment (which is to optimize map lookups of {target snippet}); and lines 10-11 indicate the prefix for the beginning of the generative neural network output.

TABLE 2

| | |
|---|---|
| 1: | cat { target path } |
| 2: | ‘‘‘ |
| 3: | { target snippet } |
| 4: | ‘‘‘ |
| 5: | Optimize the usage of maps. |
| 6: | We can accumulate results and use one-time |
| 7: | initialization to avoid unnecessary extra work. |
| 8: | ... |
| 9: | Optimize the code. |
| 10: | patch { target path } |
| 11: | @@ |

In some cases, the prompt includes examples for how to improve the performance of the identified candidate code segment.

As particular example prompt, Table 3 illustrates an example few-shot prompt with enumerated lines, where line 1 is an instruction to apply a specific code transformation, lines 2-9 are each of the few shot examples that include an example unoptimized code segment (i.e., example snippets 1 and 2) and the corresponding optimized code diff of the unoptimized code segment (i.e., example diff 1 and 2), and lines 10-12 includes the code segment to be optimized.

TABLE 3

| | |
|---|---|
| 1: | Remove redundant map lookups to improve performance. |
| 2: | Example 1 |
| 3: | { example snippet 1 } |
| 4: | @@ |
| 5: | { example diff 1 } |
| 6: | Example 2 |
| 7: | { example snippet 2 } |
| 8: | @@ |
| 9: | { example diff 2 } |
| 10: | Example 3 |
| 11: | { target snippet } |
| 12: | @@ |

In some cases, the prompt is a chain-of-thought prompt. Generally, a chain of thought prompt instructs the generative neural network to first output a plan of the required steps, before generating the optimized computer code segment.

As particular example prompt, Table 4 illustrates an example chain of thought prompt with enumerated lines. Lines 1-2 include the candidate code segment using the placeholder {target snippet}; lines 3-13 includes two instructions for the generative neural network, where the first instruction (lines 4-8) provide a specific format for the model to output its plan and the second instruction (lines 9-13) provide a specific format for the model to output the optimized code segment; and lines 14-16 indicate the prefix for the beginning of the generative neural network output.

TABLE 4

| | |
|---|---|
| 1: | # Original Code |
| 2: | { target snippet } |
| 3: | # Instructions |
| 4: | 1.Walk through how to optimize this code using |
| 5: | this format: |
| 6: | * Step 1: { step 1 } |
| 7: | * Step 2: { step 2 } |
| 8: | * Step 2: { step 3 } |
| 9: | 2. Then provide a code diff optimizing the code |
| 10: | using this format: |
| 11: | patch { target path } |
| 12: | @@ |
| 13: | { code diff } |
| 14: | # Answer |
| 15: | Let ' s think this through, step by step : |
| 16: | * Step 1: |

In some cases, the prompt is a ReAct prompt. Generally, a ReAct prompt (i.e., Reasoning+Action prompt) is one that causes the generative neural network to process reasoning steps and execute actions intended for execution in an external environment. The observed results of the executed actions are tokenized (e.g., as described above) and incorporated into the input for the generative neural network to process, allowing the generative neural network to dynamically execute a series of steps to generate an output.

As particular example prompt, Table 5 illustrates an example ReAct prompt with enumerated lines. Lines 1-2 include an instruction to optimize the candidate code segment with a placeholder for the location in the repository of {target path}; lines 3-4 include a reasoning step; lines 5-6 includes an action (executed in the terminal environment of the computing resources) the result of which is included in the input to the generative neural network; lines 7-8 includes the result of the action from lines 5-6 represented by the placeholder {target snippet}; lines 9-10 includes another reasoning step; and lines 11-13 indicate the prefix for the beginning of the generative neural network output.

TABLE 5

| | |
|---|---|
| 1: | # Instruction |
| 2: | Improve the performance of the code in { target path }. |
| 3: | # Thought |
| 4: | Let ' s take a look at the code. |
| 5: | # Action |
| 6: | cat { target path } |
| 7: | # Observe |
| 8: | { target snippet } |
| 9: | # Thought |
| 10: | Now let's edit the code to speed it up. |
| 11: | # Action |
| 12: | patch { target path } |
| 13: | @@ |

The system adds the optimized computer code segment to the repository for execution on the set of computing resources (step 206).

As described above, the system can then add the optimized version of the candidate code segment to the repository of computer code as a modification to the candidate code segment, in place of the candidate code segment, or as a new candidate code segment.

In some implementations, prior to adding the optimized computer code segment to the repository for execution on the set of computing resources, the system performs a verification process on the optimized computer code segment.

For example, the verification process can include the system leveraging a continuous integration pipeline to run automated unit and integration tests to check the correctness of the optimized computer code segment. If a build failure or test error occurs, the system can attempt to apply automated tooling to fix trivial errors. If the attempt to apply automated tooling to fix the error fails, the system can determine not to add the optimized computer code segment to the repository.

In some implementations, as part of performing a verification process on the optimized computer code segment, the system causes the generative neural network to perform self-review on the optimized computer code segment.

For example, the system can process an input that includes the optimized computer code segment along with a prompt that includes a set of questions regarding common coding errors and anti-patterns using the generative neural network. Then the system can use the output of the generative neural network for this input to verify the optimized computer code segment (i.e., verify that the output indicates no issues for the optimized computer code segment is present).

In some implementations, after the system verifies the optimized computer code segment, the system provides the optimized computer code segment to a user for verification. That is, the system provides the optimized computer code segment to a user on a user device (e.g., smartphone display, laptop display, desktop computer display, display on a computer terminal via computer display screen, etc.) and receives an input from the user verifying the optimized code segment (i.e., an input from the user indicating the optimized code segment is correct, e.g., a user submitting an ‘accept’ command in a computer terminal as an input). For example, upon passing all automated verification steps, the system can present the optimized code segment to a human reviewer, e.g., a reviewer designated as code owner, who is then responsible for providing the verification.

The system can repeatedly perform steps 202-206 to continuously optimize the computer code of the repository.

This continuous process is advantageous because a large repository of computer code is not static but is constantly evolving, e.g., with new code additions and modifications from programmers. By repeatedly performing these steps, the system ensures that new optimization opportunities are identified and addressed as they emerge, leading to a sustained and continuous improvement in the overall performance of the computer code within the repository and the efficiency of the computing resources that execute it.

For example, the system can repeat the above steps until one or more criteria are satisfied (e.g., the system performs a pre-determined number of iterations, the system's additions of optimized computer code to the repository no longer exceed a minimum amount, and so on). Repeatedly performing the above steps without intermediate programmer additions to the repository of code is advantageous because for each addition to the computer code of the repository the system makes there are potentially new opportunities for code optimization.

As another example, the system can repeat the above steps periodically (at pre-determined time intervals, e.g., every hour, every day, every week, every month, and so on).

As another example, the system can repeat the above steps every time a condition is met, e.g., every time a programmer adds code to the repository.

FIG. 4 is a flow diagram of an example process 400 for fine-tuning a deep embedding model. For convenience, the process 400 will be described as being performed by a system of one or more computers located in one or more locations. For example, an efficient code optimization system, e.g., the efficient code optimization system 100 of FIG. 1, appropriately programmed in accordance with this specification, can perform the process 400.

As described above, the deep embedding model can have any of a variety of neural network architectures. That is, the deep embedding model can have any appropriate architecture in any appropriate configuration such that the deep embedding model can process a code segment to generate an embedding representation of the code segment, including fully connected layers, convolutional layers, recurrent layers, attention-based layers, and so on, as is appropriate.

For convenience, example process 400 will be described for a deep embedding model that is a dual-embedding model whose architecture consists of two encoders. The two encoders of this dual-embedding model include a query encoder that will process a representative code segment associated with an optimization archetype after pre-training and a candidate encoder that will process a candidate code segment after pre-training.

The system repeatedly updates the trainable parameters of the deep embedding model using a training data set. That is, the system can repeatedly perform the following described example process using training examples to repeatedly update all or a subset of the trainable parameters of the deep embedding model from previously determined values, e.g., pre-trained values.

The system obtains a training data set that includes training examples that each includes a training pair of two code segments (step 402), where each training example includes a training pair of two code segments.

As described above, in some cases, the training dataset includes a set of training pairs where, for each training pair, the two code segments are semantically similar function pairs; and, optionally, a set of training pairs where, for each training pair, one code segment is a code diff between a before code segment and an after code segment and the other code segment is the before code segment.

In some cases, the system first fine-tunes the deep embedding model using the set of training pairs where, for each training pair, the two code segments are semantically similar function pairs. Then, after fine-tuning with this set of training pairs, the system fine-tunes the deep embedding model using the other set of training pairs where, for each training pair, one segment is a code diff between a before code segment and an after code segment and the other code segment is the before code segment. That is, the system performs steps 402-408 using one of the sets of training pairs, then the system performs steps 402-408 using the other set of training pairs.

The system can obtain the training data set from any of a variety of sources (e.g., system maintained data, a user, another system, and so on). For example, the system can obtain the training data from the repository of computer code, curated additional data sources, or both.

The system generates an embedding representation of each code segment in the training pair for each training example (step 404). That is, for each training example, the system processes the two code segments of the training pair using the deep embedding model through the model's two respective encoders. Therefore, each encoder generates an embedding, and the system generates a pair of embeddings for each training example. When a training pair includes two semantically similar code segments, the system assigns one segment to the query encoder and the other to the candidate encoder for processing, with the assignment being arbitrary. But when the training pair includes a code diff and a before code segment, the system assigns the code diff to the query encoder and the before code segment to the candidate encoder for processing.

The system evaluates an objective that includes a loss function for each training example (step 406).

The loss function for each training example can be any appropriate loss function that measures the similarity between the pair of output embeddings generated in the previous step 404 as described above. For example, the loss can be based on the similarity metric, e.g., Cosine similarity, Cosine distance, Euclidean distance, Manhattan distance, and so on. As a particular example, the loss function can be a contrastive loss function that includes a similarity metric, e.g., LeCunn contrastive loss as described in Hadsell, R., Chopra, S., & LeCun, Y. (2006). Dimensionality Reduction by Learning an Invariant Mapping. 2006 IEEE Computer Society Conference on Computer Vision and Pattern Recognition-Volume 2 (CVPR '06), New York, United States, pp. 1735-1742. Other example loss functions include SimCLR as described in arXiv: 2002.05709, MoCO as described in arXiv: 1911.05722, and infoNCE as described in Gutmann, Michael, and Aapo Hyvärinen. “Noise-contrastive estimation: A new estimation principle for unnormalized statistical models.” Proceedings of the thirteenth international conference on artificial intelligence and statistics. JMLR Workshop and Conference Proceedings, 2010.

The system updates trainable parameters to optimize the objective (step 408).

The system can update the trainable parameters of the deep embedding model in any variety of ways, e.g., gradient based method, evolutionary algorithm-based method, Bayesian optimization, etc.

For example, the system can optimize the objective using any of a variety of gradient descent techniques (e.g., batch gradient descent, stochastic gradient descent, or mini-batch gradient descent) that include the use of a backpropagation technique to estimate the gradient of the loss with respect to trainable parameters of the neural network and to update the learnable parameters accordingly.

The goal of optimizing the objective is to ensure that pairs of code segments that are intended to be similar (like a code diff and the code it applies to, or two semantically similar functions) have similar embeddings, while dissimilar pairs have dissimilar embeddings.

Generally, the system repeats the above steps until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

FIG. 5 is a flow diagram of an example process 500 for fine-tuning a generative neural network. For convenience, the process 500 will be described as being performed by a system of one or more computers located in one or more locations. For example, an efficient code optimization system, e.g., the efficient code optimization system 100 of FIG. 1, appropriately programmed in accordance with this specification, can perform the process 500.

As described above, the generative neural network can have any of a variety of neural network architectures. For convenience, example process 500 will be described for a generative neural network configured to process a sequence of tokens to auto-regressively generate an output sequence of tokens.

The system repeatedly updates the trainable parameters of the generative neural network using a training data set. That is, the system can repeatedly perform the following described example process using training examples to repeatedly update all or a subset of the trainable parameters of the generative neural network from previously determined values, e.g., pre-trained values.

The system obtains a training data set that includes training examples (step 502), where each training example includes a training input that includes a training code segment and a target output that represents the optimized code segment (i.e., the optimized version of the training code segment). The training input can also optionally include prompts (i.e., prompts as described above).

The system can obtain the training data set from any of a variety of sources (e.g., system maintained data, a user, another system, and so on). For example, the system can obtain the training data from the repository of computer code, curated additional data sources, or both.

As described above, in some cases, when each optimization archetype corresponds to a respective set of one or more anti-pattern fixing commits that each fix undesirable code usage of code within the repository, the training dataset can include, for each anti-pattern fixing commit, the before and after code segment according to the commit (i.e., the original code segment and the optimized version of code segment) as a training example. In particular, each training example can include a training input that includes a training code segment that represents the before code segment of the commit and a target output that represents the after code segment of the commit or the code diff of the commit. A particular example of a training example for this case is described above with reference to Table 1.

The system, for each training example, generates an output (step 504), where the output includes an optimized code segment for the training code segment of the training example. That is, for each training example, the system processes the training input using the generative neural network to generate the respective optimized code segment for the training code segment included in the training input. For example, the generative neural network processes lines 1-14 of the particular training example of table 1 above to generate the output, e.g., the generative neural network processes lines 1-14 auto-regressively as described above for an auto-regressive neural network to generate an output sequence. Therefore, the system generates an output that includes a representation of the optimized code segment for each training example.

The system evaluates an objective that includes a loss function for each training example (step 506).

The loss function for each training example can be any appropriate loss function that measures the difference between the generated output of the generative neural network and the target output (i.e., the difference between the optimized code segment generated by the generative neural network for the training code segment and the true optimized code segment for the training code segment). For example, the loss function can be the cross-entropy loss over token representations of the output and the target output.

The system updates trainable parameters to optimize the objective (step 508).

The system can update the trainable parameters of the generative neural network in any variety of ways, e.g., gradient based method, evolutionary algorithm-based method, Bayesian optimization, etc.

For example, the system can optimize the objective using any of a variety of gradient descent techniques (e.g., batch gradient descent, stochastic gradient descent, or mini-batch gradient descent) that include the use of a backpropagation technique to estimate the gradient of the loss with respect to trainable parameters of the neural network and to update the learnable parameters accordingly.

Generally, the system repeats the above steps until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

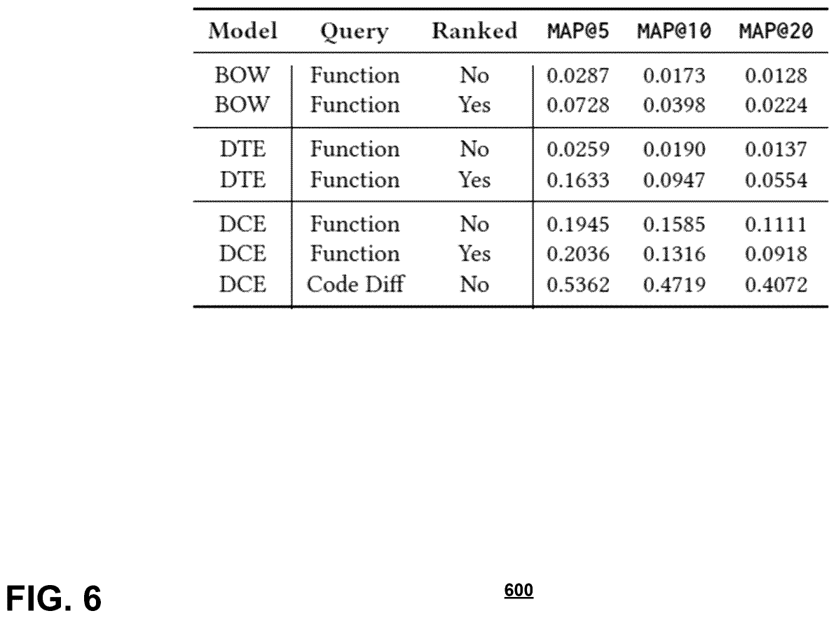

FIG. 6 is an example 600 of the performance of the described techniques.

In particular, example 600 shows a table that summarizes the described techniques' performance in terms of mean average precision (i.e., “MAP”) for identifying a plurality of candidate code segments that are candidates for optimization after performing a search through a repository of computer code for various aspects of the described techniques.

The column labeled “Model” refers to the embedding design for archetype embeddings and segment embeddings, where “BOW” refers “Bag of words” as described above, “DTE” (i.e., “deep text embedding) refers to the use of a deep embedding model without fine-tuning as described above, and DCE refers to the use of a deep embedding model with fine-tuning as described above.

The column labeled “Query” refers to the kind of representative code segment (i.e., “function” refers to lines of computer code and “code diff” refers to lines of computer code that are added, removed, or modified to transform original lines of computer code to optimized lines of computer code) that each optimization archetype is associated with.

The column labeled “Ranked” refers to using syntactic similarities of code segments represented by the initial set of segment embeddings to the representative code segment for the optimization archetype to filter the code segments.

The columns labeled “MAP@5”, “MAP@10”, and “MAP@20” refers to mean average precision of the top 5, 10, and 20 identified code segments that are candidates for optimization. That is, MAP@K represents the average rate identified code segments of the top K are ones that can be optimized via the optimization type (e.g., anti-pattern) the optimization archetype represents.

Example 600 shows that finetuning the deep embedding model, and the use of syntactic similarity to filter initial code segments significantly improve the performance of identifying an appropriate plurality of candidate code segments that are candidates for optimization.

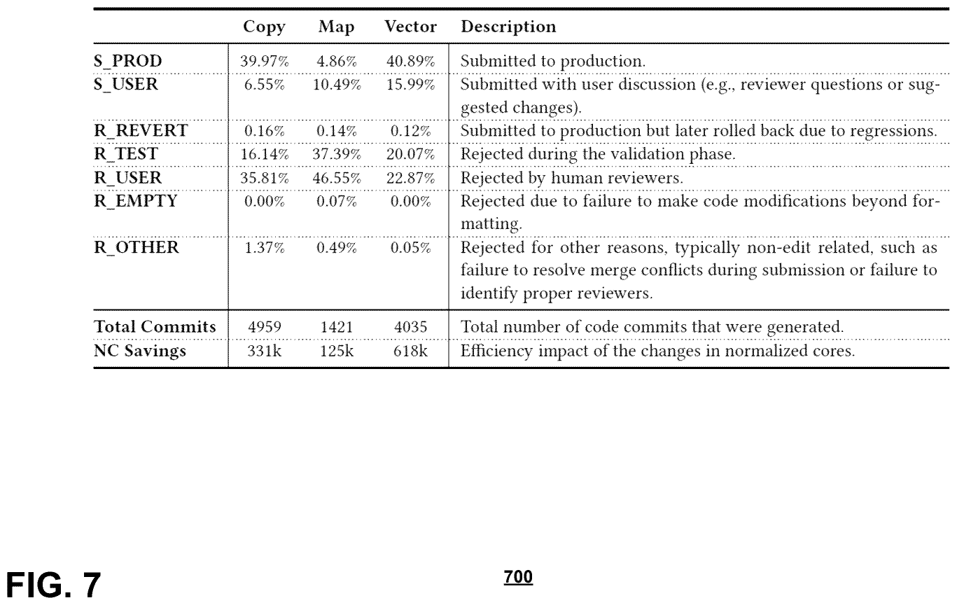

FIG. 7 is an example 700 of the performance of the described techniques.

In particular, example 700 shows a table that summarizes the performance of the described techniques to optimize computer code from a repository of computer code in terms of NC or normalized cores (i.e., a unit that measures computer processing savings as number of MIPS (100 million instructions per second) divided by the MIPS provided by a single core on a specific hardware platform).

The columns labeled “Copy”, “Map”, “Vector” refer to optimization types (i.e., anti-patterns) represented by a set of one or more performance optimization archetypes. The row labeled “total commits” refers to the number of code segments that have been optimized and the row labeled “NC savings” refers to the total computer processing saved.

Example 700 shows that the described techniques (for a set of three performance optimization archetypes) added over 10,000 code segments to the repository which yielded computational savings of over one million normalized cores.

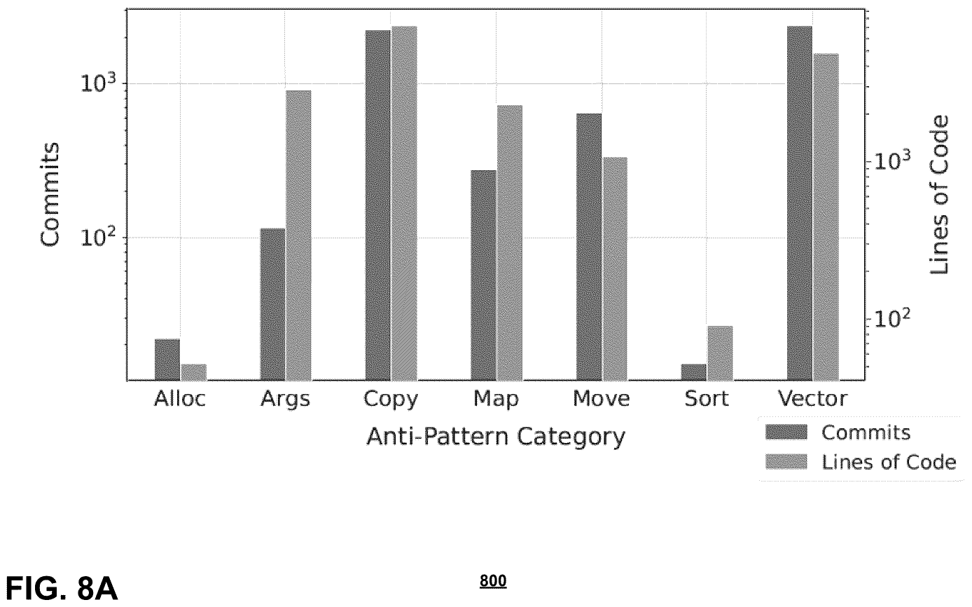

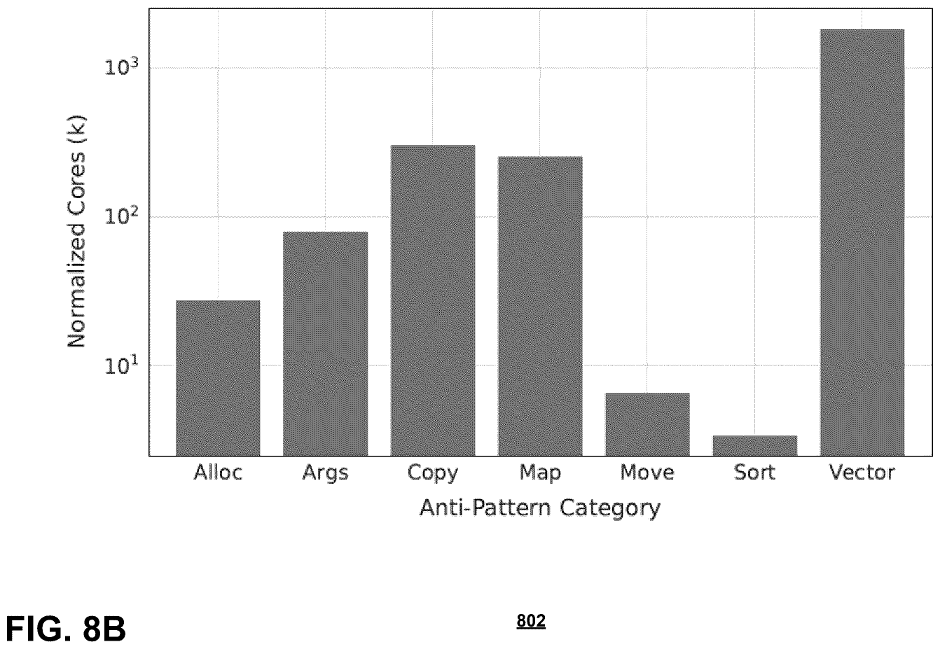

FIG. 8A is an example 800 of the cumulative performance of the described techniques operating continuously over the course of approximately one year on a repository of computer code that contains billions of lines of code and that code being executed across millions of servers in numerous data centers worldwide.

In particular, example 800 shows a bar plot the quantifies the code segments added to the repository of computer code for each of a set of performance optimization archetypes (referred to as the anti-pattern categories Alloc, Args, Copy, Map, Move, Sort, and Vector). In total, the described techniques added over twenty-five thousand lines of code to the repository across 6.4 thousand commits.

FIG. 8B is also an example 802 of the cumulative performance of the described techniques for the same context as described above for example 800 but in terms of normalized cores (described above). In particular, example 802 shows that the described techniques result in over 2M normalized cores of savings as a bar plot of normalized cores per optimization types represented by the set of performance optimization archetypes (and referred to as the anti-pattern categories Alloc, Args, Copy, Map, Move, Sort, and Vector).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
performing a search through a repository of computer code to identify a plurality of candidate code segments that are candidates for optimization, wherein the repository of computer code stores computer code for execution on a set of computing resources;
for each identified candidate code segment:
processing an input comprising the identified candidate code segment using a generative neural network to generate an optimized computer code segment that represents an optimized version of the identified candidate code segment; and
adding the optimized computer code segment to the repository for execution on the set of computing resources.

2. The method of claim 1, wherein performing a search through a repository of computer code to identify a plurality of candidate code segments that are candidates for optimization comprises:
maintaining a respective archetype embedding of each performance optimization archetype in a set of one or more performance optimization archetypes;
maintaining a respective segment embedding of each of a first plurality of code segments in the repository;
for one or more of the performance optimization archetypes in the set:
performing a search of the respective segment embeddings to identify one or more respective segment embeddings that are similar to the respective archetype embedding for the performance optimization archetype; and
identifying, as candidate code segments, the code segments that are represented by the respective segment embeddings that are similar to the respective archetype embedding.

3. The method of claim 2, wherein each optimization archetype is associated with a representative code segment, and wherein the method further comprises:
generating the respective archetype embedding for the optimization archetype by processing the representative code segment associated with the optimization archetype using a deep embedding model.

4. The method of claim 3, further comprising:
generating the respective segment embedding of each of the first plurality of code segments in the repository by processing the code segment using the deep embedding model.

5. The method of claim 3, wherein the deep embedding model is a dual-embedding model.

6. The method of claim 3, wherein the deep embedding model has been fine-tuned on a training data set that includes a plurality of training pairs that each include a first code segment and a second code segment.

7. The method of claim 6, wherein, for a first set of the training pairs, the first code segment and the second code segment are semantically similar function pairs.

8. The method of claim 6, wherein, for a second set of the training pairs, the first code segment is a code diff between a before code segment and an after code segment and the second code segment is the before code segment.

9. The method of claim 2, further comprising:
maintaining respective performance metrics for each of a second plurality of code segments in the repository that measure a performance of the code segment when the code segment has been executed on the set of computing resources.

10. The method of claim 9, wherein the second plurality of code segments include the first plurality of code segments and a third plurality of code segments, and wherein the method further comprises:
determining not to maintain respective segments embeddings of the third plurality of code segments based on the respective performance metrics for the third plurality of code segments.

11. The method of claim 10, wherein determining not to maintain respective segments embeddings of the third plurality of code segments based on the respective performance metrics for the third plurality of code segments comprises:
determining not to maintain respective segments embeddings of the third plurality of code segments based on determining that the respective performance metrics for the third plurality of code segments indicate that the third plurality of segments have less than a threshold level of compute usage.

12. The method of claim 2, wherein each optimization archetype corresponds to a respective set of one or more anti-pattern fixing commits that each fix undesirable code usage of code within the repository.

13. The method of claim 2, wherein each optimization archetype is associated with a representative code segment.

14. The method of claim 13, wherein each optimization archetype corresponds to a respective set of one or more anti-pattern fixing commits that each fix undesirable code usage of code within the repository, and wherein, for one or more of the optimization archetypes, the representative code segment represents one or more code segments that have been fixed by the respective set of one or more anti-pattern fixing commits.

15. The method of claim 13, wherein each optimization archetype corresponds to a respective set of one or more anti-pattern fixing commits that each fix undesirable code usage of code within the repository; and wherein, for one or more of the optimization archetypes, the representative code segment represents a code diff corresponding to the respective set of one or more anti-pattern fixing commits.

16. The method of claim 13, wherein performing a search of the respective segment embeddings to identify one or more respective segment embeddings that are similar to the respective archetype embedding for the performance optimization archetype comprises:
performing the search of the respective segment embeddings to output a first set of segment embeddings; and
filtering the first set of segment embeddings based on respective similarities of the code segments represented by the first set of segment embeddings to the representative code segment for the optimization archetype.

17. The method of claim 16, wherein the respective similarities are syntactic similarities.

18. The method of claim 1, wherein the input comprising the identified candidate code segment further comprises a prompt for the generative neural network.

19. The method of claim 18, wherein the prompt instructs the generative neural network to apply a specific code transformation to the identified candidate code segment.

20. The method of claim 18, wherein the prompt instructs the generative neural network to improve a performance of the identified candidate code segment.

21. The method of claim 20, wherein the prompt is a chain-of-thought prompt.

22. The method of claim 20, wherein the prompt is a ReAct prompt.

23. The method of claim 1, further comprising:
prior to adding the optimized computer code segment to the repository for execution on the set of computing resources, performing a verification process on the optimized computer code segment.

24. The method of claim 23, wherein performing a verification process on the optimized computer code segment comprises:
causing the generative neural network to perform self-review on the optimized computer code segment.

25. The method of claim 2, wherein the generative neural network has been fine-tuned on training data derived from the optimization archetypes.

26. A system comprising one or more computers and one or more storage devices storing instructions that when executed by the one or more computers cause the one more computers to perform operations, the operations comprising:
performing a search through a repository of computer code to identify a plurality of candidate code segments that are candidates for optimization, wherein the repository of computer code stores computer code for execution on a set of computing resources;
for each identified candidate code segment:
processing an input comprising the identified candidate code segment using a generative neural network to generate an optimized computer code segment that represents an optimized version of the identified candidate code segment; and
adding the optimized computer code segment to the repository for execution on the set of computing resources.

27. One or more computer storage media storing instructions that when executed by one or more computers cause the one more computers to perform operations, the operations comprising:
performing a search through a repository of computer code to identify a plurality of candidate code segments that are candidates for optimization, wherein the repository of computer code stores computer code for execution on a set of computing resources;
for each identified candidate code segment:
processing an input comprising the identified candidate code segment using a generative neural network to generate an optimized computer code segment that represents an optimized version of the identified candidate code segment; and
adding the optimized computer code segment to the repository for execution on the set of computing resources.
